(19) United States
(12) Patent Application Publication
(10) Pub. No.: US 2009/0299993 A1
(43) Pub. Date: Dec. 3, 2009

(54) Candidate Recruiting

(76) Inventor: Michael D. Novack, St. Louis, MO (US)

Correspondence Address: FISH & RICHARDSON PC, P.O. BOX 1022, MINNEAPOLIS, MN, 55440-1022, US

(21) Appl. No.: 12/130,954

(22) Filed: May 30, 2008

(51) Int. Cl. G06F 17/30; G06Q 10/00; G06Q 30/00

(52) U.S. Cl. 707/5; 705/7; 705/26; 705/10; 707/E17.071

(57) ABSTRACT

Methods and systems for candidate recruiting are described. Bio/demographic information and behavioral data is collected from candidates and processed to provide score signals. The score signals are transduced to an observable form and made available along with the data to employers and organizations for use in identifying candidates of interest for employment and other purposes. The candidates may be offered incentives for providing information to the service.

### BACKGROUND OF THE INVENTION

This invention relates to candidate recruiting. A recruiting site is described in Taylor, U.S. Pat. No. 5,832,497, in which employers post descriptions of available positions and candidates submit their resumes to the site to apply for posted positions.

### BRIEF SUMMARY OF THE INVENTION

The invention provides systems and methods, including computer program products, for candidate recruiting.

In general, in one aspect, the invention features a computer-implemented method that includes: processing trait signals representative of quantitative assessments of traits possessed by a candidate and weighting signals representative of relative degrees of importance of the traits perceived by the employer to provide a score signal based on the trait signals and weighting signals; and transducing the score signal to an observable form.

In general, in another aspect, the invention features a computer-implemented method that includes: receiving an interest signal representative of an indication of interest in a particular career role from a candidate; generating a query signal representative of a query targeted to the particular career role for soliciting information from the candidate; transducing the query signal to an observable form displayed to the candidate; receiving a response signal representative of the response of the candidate to the transduced query signal; and determining a measure of competency of the candidate for the particular career role by comparing the response signal with a template signal received from an employer, the template signal being representative of a template that defines a desired candidate profile for the particular career role.

In general, in a further aspect, the invention features a computer-implemented method that includes: storing user profiles in memory, the user profile data including objective information provided by the candidates and quantitative assessments of behavioral and personality traits of the candidates; filtering the user profiles based on criteria signals representative of criteria selected from the objective information; and ordering remaining user profiles according to scores assigned to the user profiles and determined from the quantitative assessments.

In general, in a further aspect, the invention features a computer-implemented method that includes: determining score signals representative of scores corresponding to candidates, the scores representing a likelihood of the candidates succeeding in career roles for which the candidates have expressed interest, the scores determined, at least in part, from quantitative assessments of behavioral and personality traits of the candidates; producing an information signal representative of information derived from one or more of the quantitative assessments and scores; and deriving revenue from a third in exchange for transducing the information signal into an observable form for display to the third party.

In general, in a further aspect, the invention features a computer-implemented method that includes: enabling a user affiliated with an employer to access a list of candidates from an online system, the list of candidates ranked according to a measure of qualification for a career role, the measure of qualification determined based on a quantitative input signal representing quantitative input provided by the employer, the quantitative input being representative of a desired candidate for the career role; and compensating a provider of the online system before or after completion of an activity involving one or more candidates from the list.

In general, in a further aspect, the invention features a system that includes: memory storing information received from candidates and quantitative assessments of behavioral and personality traits of the candidates, and weightings provided by a user affiliated with an employer, the weightings indicating relative degrees of importance of the behavioral and personality traits; and one or more processors configured to determine scores for the candidates based on the quantitative assessments and based on the weightings.

In general, in a further aspect, the invention features a computer-implemented method that includes: storing in memory, user profile data received from candidates interested in a career opportunity, the user profile data including objective information provided by the candidates and quantitative assessments of behavioral and personality traits of the candidates; generating statistical information from the user profile data; and generating a direct marketing list based on the statistical information, the direct marketing list being available for purchase by one or more third parties.

Embodiments may provide one or more of the following advantages. The candidate recruiting service provides a cost effective and efficient means for employers and recruiters to search and source qualified candidates for various employment positions. Employers are provided with quantitative assessments of candidates' behavioral and personality traits, aptitude in various competency areas, and proficiency in job-specific skills. Candidates are assigned scores based on criteria input by an employer for a specific role. Employers and recruiters can quickly determine which candidates are a best fit for an employment position according to how the candidates scores compare with each other. The candidate recruiting service may be used by other entities besides employers for searching and sourcing talented individuals. For example, non-profit organizations can use the candidate recruiting service to find volunteers, e.g., for a community center or political campaign.

Feedback, e.g., reports, based on quantitative assessments of a candidate may be provided to one or more of the candidate, employer, recruiter, and career counselor. The system may provide financial incentives to encourage candidates to register, complete, and update their profiles. The system sets restrictions on how many times candidates can undergo behavioral and personality assessments to prevent candidates from taking multiple assessments within a short period of time or attempting to “game” or “cheat” the assessments. The system elicits information from users using job-specific questionnaires that generate follow-up questions in response to the candidates' answers. The system streamlines communication between employers and candidates by integrating communication tools with the system.

The details of one or more embodiments are set forth in the accompanying drawings and the description below. Other features, objects, and advantages will be apparent from the description and drawings, and from the claims.

### BRIEF DESCRIPTION OF THE SEVERAL VIEWS OF THE DRAWING

FIGS. 1A-C show a block diagram of a candidate recruiting system,

FIG. 2 is a flowchart of a process for recruiting a candidate,

FIG. 3 is a flowchart of a process for providing candidate recruiting services to an employer,

FIGS. 4-6 show exemplary features of the employer user console.

FIG. 7 shows a comparison report.

### DETAILED DESCRIPTION

Described is a candidate recruiting service that enables employers and recruiters to find candidates for positions, and that also enables potential candidates, e.g., students as well as experienced hires, to make themselves available to employers and recruiters seeking to fill employment positions. Unlike many conventional recruiting systems, the candidate recruiting service does not solicit ads for available positions from employers and then push these ads out to potential candidates. Rather, the service creates user profiles for potential candidates from a variety of information solicited from the candidates through the service. A profile of a candidate, for example, includes the candidate's career field and role preferences (e.g., software development or sales); geographic preferences, a date (or expected date) of graduation, and quantitative assessments of the candidate's behavioral and personality traits and aptitude in various competency areas. As will be described further below, the quantitative assessments are determined by the system based on the candidate's answers to questions that target different traits and skills.

The service enables employers and recruiters acting on behalf of employers to view candidate profiles, filter and/or search the profiles according to the data available in the profiles, and input criteria for evaluating candidates based on the candidates' quantitative assessments. For example, the service determines scores for the candidates based on the employer criteria and quantitative assessments, where a score assigned to a candidate represents the likelihood that the candidate will succeed in a particular career role or position. The service returns a list of the candidates ranked according to their scores, and from the list, an employer can quickly and easily locate the presumably most qualified candidates, and contact them through service. Thus, the candidate recruiting service can provide a broader pool of initial candidates than that obtained using job postings and other conventional recruiting methods and also help employers to narrow down a pool of candidates in an efficient and intelligent manner.

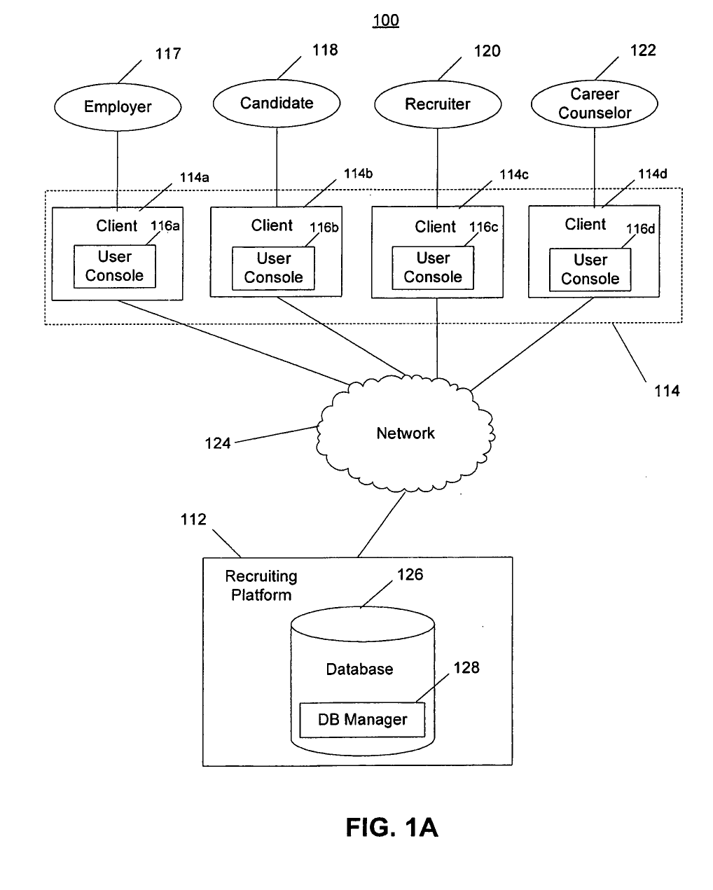

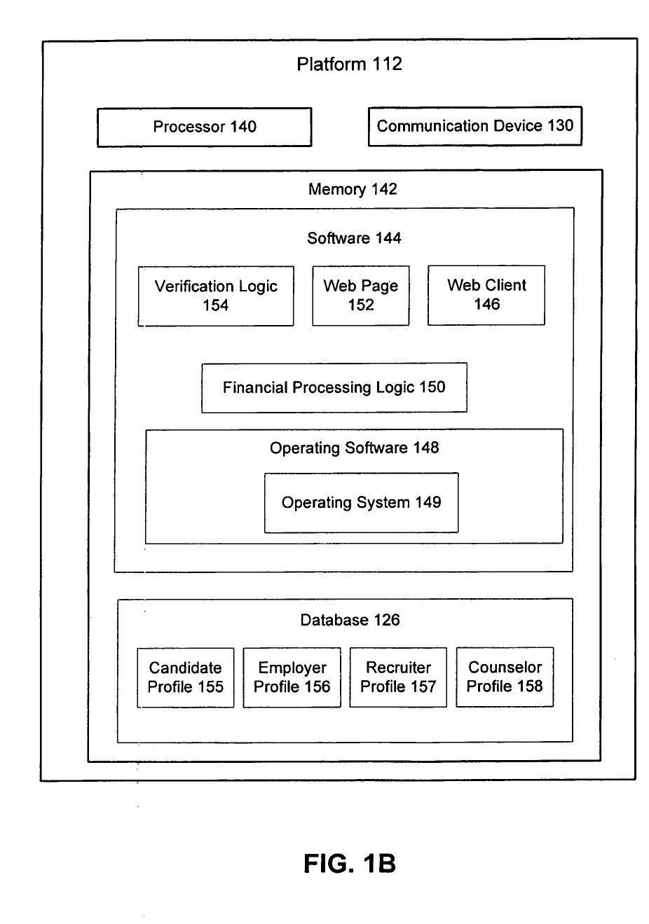

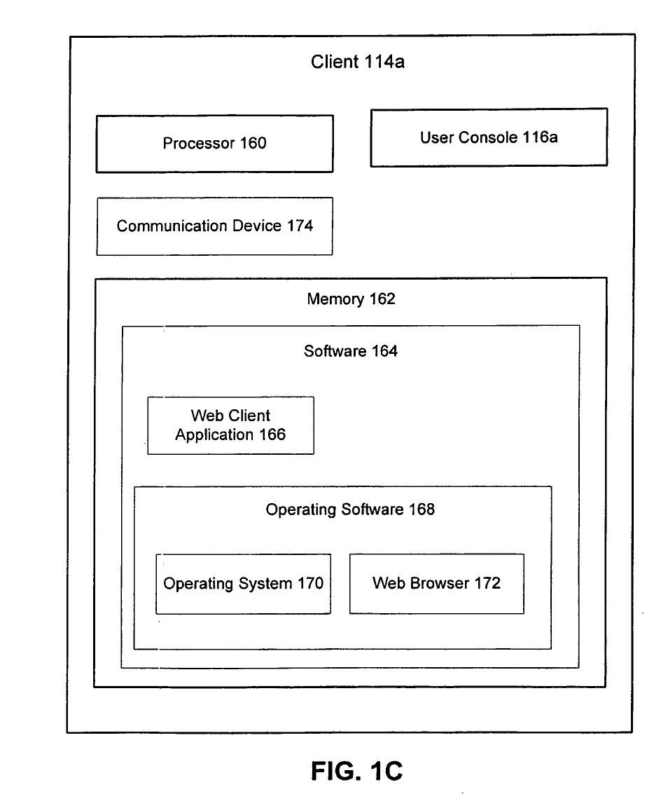

Referring to FIG. 1A, a candidate recruiting system 100 includes a platform 112 coupled to client computers 114a-114d (collectively referred to as “clients 14”) via a network 124 (e.g., a LAN, WAN, the Internet, or a combination thereof), and a database 126 coupled to the platform 112. Although the database 126 is shown to be internal to the platform 112, it could be external to the platform 112 and could include multiple databases. The database 126 stores information provided by employers (e.g., employer profiles, account info, etc.) and information provided by candidates (e.g., candidate profiles, resumes, account info, etc.). The platform 112 controls and facilitates the exchange of information between users of the candidate recruiting service. The term “service” includes all of the features, systems, and methods described here for delivering candidate recruiting services through the platform 112. The platform 112 includes privacy controls that allows candidates to control who can view their profile or contact them, among other functions. In some embodiments, the platform 112 masks candidate identification and contact information until a request has been initiated by an employer 117 and the candidate 118 approves the request.

The database 126 includes a database manager 128 for managing the contents of the database 126, applying privacy controls, and performing other functions that make use of the contents in the database 126.

Users include employers, candidates, recruiters working on behalf of employers, and career counselors, such as those at universities and colleges. An employer 117, a candidate 118, a recruiter 120, and a career counselor 122 access the platform 112 using the clients 114a-114d, respectively. The employer 117 is any legal entity, which can include, for example, a public company, a private company, and a non-profit organization. The candidate 118 is any person who is interested in obtaining employment, for example, a student, a person out of work, or a current employee who wants to change jobs or careers. The recruiter 120 acts on behalf of an employer 117 to locate qualified candidates for an employment position offered by the employer 117. The career counselor 122 is typically a third party that accesses information from the platform 112 primarily to advise candidates associated with his or her place of employment (e.g., a university or employment assistance office) and for research purposes. Both the recruiter 120 and the career counselor 122 may each be an individual, a group of individuals, a company, or an organization.

The client computers 114a-b (collectively referred to as “client computers 114”) include consoles 116a-b (collectively referred to as “user consoles 116”), which are user interfaces through which the employer 117, candidate 118, recruiter 120, and career counselor 122 interact with the platform 112. Via a user console, a user registers with the platform 112, which in turn creates an account or profile for the user and stores the profile in the database 126. A user profile includes identification information and contact information associated with the user and other information supplied by the user.

Referring to FIG. 1B, the platform 112 may be any type of computing device or multiple computing devices. The platform 112 includes one or more processor(s) 140 (referred to simply as “processor 140”), a communication device 130, and memory 142 that executes software 144. Communication device 130 converts information to a form that is suitable for transmission over the network 124. In some implementations, communication device 130 is a modem that converts digital signals into analog sound signals for transmission over a telephone line. In other implementations, communication device 130 is an Ethernet card that converts information into packets for transmission over an Ethernet LAN. Other examples of communication device 130 include wireless access cards, and other network access hardware.

Software 144 includes verification logic 154 for authenticating users, a Web portal 152 for interfacing with users, a Web client application 146 for enabling communication with the clients 114, and the database manager 128. The Web client application 146 includes one or more routines used in implementing communication protocols (e.g., TCP/IP protocols) that allow the platform 112 to communicate over network 124 using the communication device 130. The platform 112 also includes an operating system software environment 148 that includes, but that is not necessarily limited to, an operating system 149.

The Web portal 152 is a group of Web pages (i.e., electronic documents) that provides users with an interface to access the recruiting service via the Internet and/or World Wide Web. The Web portal 152 provides the user with tools for entering information and customizing the display of information, e.g., sorting, filtering, and indexing information.

Verification logic 154 receives authentication information entered by a user trying to access the recruiting service through Web portal 152. The authentication information includes a username and password. The authentication information may also include digital certificates that allow verification logic 154 to authenticate the identity of the user via third party verification from an independent certificate authority. After verifying the identity of the user, the verification logic 154 grants the user access to Web portal 152, through which the user accesses the recruiting service.

In memory 142, the platform 112 stores a database 126 of user profiles, which include candidate profiles 155, employer profiles 156, recruiter profiles 157, and career counselor profiles 158.

The candidate profile 155 includes information submitted by the candidate 118, referred to as “objective information.” In this context, objective information includes factual information that can be independently verified and information relating to an opinion of the candidate that can be wholly verified by the candidate, e.g., such as the candidate's preference for a particular career role. The objective information in a candidate's profile may include, but is not limited to, career interests, geographic preferences, contact information, dates or expected dates of graduations, previous work experience, names of degree-granting institutions, major or field of study, grade point averages, and standardized test scores. The candidate profile 155 may also include quantitative behavioral, personality, competency, and job-specific skills assessments, referred to collectively as “quantitative assessments,” that are determined from information provided by the candidate in response to system-initiated queries. The quantitative assessments may include scores assigned to various personality and behavioral traits and individual competency areas. Examples of personality and behavioral traits may include, but are not limited to: assertiveness, conscientiousness, helpfulness, sociability, and problem solving. Examples of competency areas may include, but are not limited to: generating new business, providing service, working on abstract problems, or managing others. Examples of job-specific skills may include, but are not limited to: clerical skills, foreign language proficiency, specialized knowledge (e.g., knowledge of a particular software package and/or machine), and quantitative ability (e.g., an ability to perform mental calculations).

An employer profile 156 features information about the employer 117, such as a company prospectus, which includes the company name and a description of the company and the composition and structure of the company. The employer profile 156 also includes information relating to the qualifications and credentials that the employer 117 seeks in a qualified candidate for a particular career opportunity. As will be described in further detail below, the employer profile includes criteria in the form of “weightings” provided by the employer 117. The weightings indicate relative degrees of importance of various behavioral and personality traits and competency area assessments. In some embodiments, weightings are values selected from a range or scale (e.g., a scale of 1 to 10) where the lowest value of the range represents the highest degree of importance and the highest value represents the lowest degree of importance as perceived by the employer 117. In some embodiments, the weightings are values that collectively sum to a predefined value, e.g., 100 or 100%.

The recruiter profile 157 may includes the contact information of the recruiter 120 and may include the name of the employer represented by the recruiter. The recruiter profile 157 also includes the same type of information included in the employer profile 156.

The career counselor 158 profile may include the contact information of the career counselor 122 and information about the entity (e.g., company, institution, university) to which the career counselor 122 is affiliated. The career counselor profile 158 also includes a list of, or criteria of, candidates affiliated with the same entity (e.g., students of a university) that are registered with the recruiting service. Additionally, the career counselor profile 158 may include information pulled from the profiles of affiliated candidates.

Referring to FIG. 1C, the client device 114a is shown in further detail. The client devices 114b-c are analogous to the client device 114a and thus include the same or similar components shown in FIG. 1C for the client device 114a. In some examples, the client devices 114 may be any type of Web-enabled apparatus or system including but not limited to a desktop computer, a laptop computer, a mainframe computer, a cellular telephone, a personal digital assistant (“PDA”), and a controller embedded in an otherwise non-computing device. The client device 114a includes one or more processor(s) 160 (referred to simply as “processor 160”), a communication device 174, and memory 162 for storing software 164.

The communication device 174 converts information to a form that is suitable for transmission over the network 124. In some implementations, the communication device 174 is a modem that converts digital signals into analog sound signals for transmission over a telephone line. In other implementations, the communication device 174 is an Ethernet card that converts information into packets for transmission over an Ethernet LAN. Other examples of the communication device 174 include wireless access cards, and other network access hardware.

The processor 160 executes software 164, which includes a Web client application 166 and operating software 168. Web client application 166 includes one or more routines used in implementing one or more communication protocols (e.g., the TCP/IP protocols), which allow the client device 114a to communicate over the network 124 with the platform 112 using the communication device 174. The operating software 168 includes an operating system 170 and a Web browser 172. The Web browser 172 enables the user (i.e., employer 117, candidate 118, recruiter 120; or career counselor 122) to interact with Web pages provided by the Web portal 152. Although loosely described as a client-server model, the system 100 can be implemented in other configurations.

The clients 114 and the platform 112 transmit information to each other in the form of signals which may be in the from of electrical impulses or electromagnetic waves. Each of the processors 140 and 160 process one or more signals received as inputs to generate one or more output signals. The information represented in a signal is transduced or rendered to an observable form though an output device, e.g., a monitor, speakers, printer, etc. Examples of transducing a signal to an observable form include but are not limited to one or more of: displaying information encoded in the signal onto a monitor or screen, printing the information in hardcopy form, and playing an audio signal.

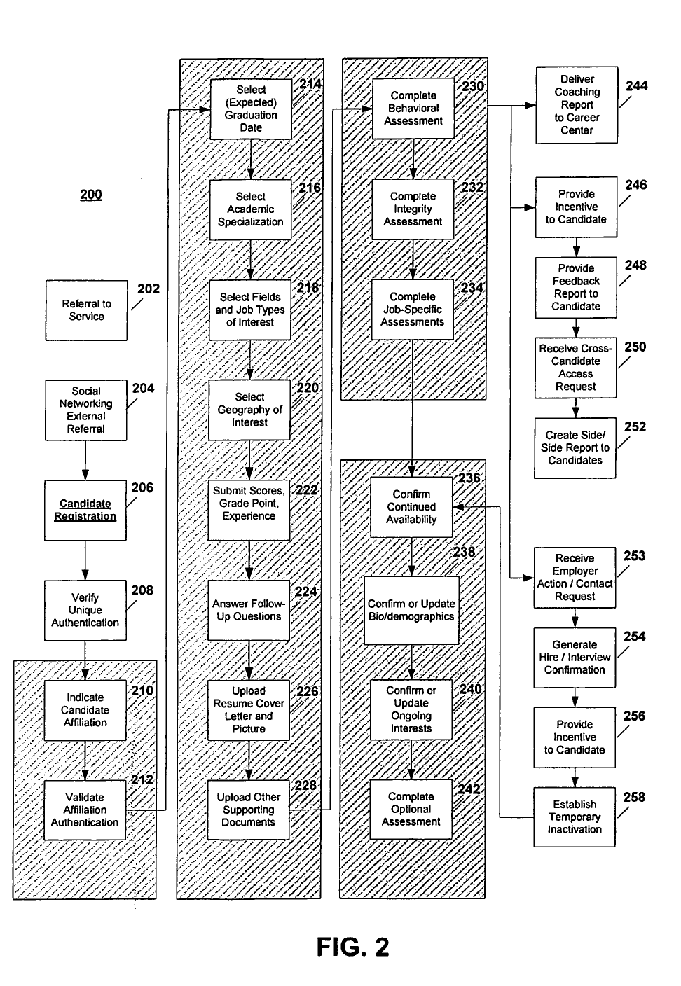

Referring to FIG. 2, the platform 112, operating in conjunction with a client computer 116b, performs a process 200 for providing recruiting services to a candidate 118 interacting with the platform 112. Having been referred to the service through marketing materials (202), a colleague, or through a social networking site (204), the candidate 118 accesses the Web portal 152 of the recruiting service. The process 200 registers (206) the candidate 118 to use the recruiting service.

During registration (206), the process 200 solicits information from the candidate 118, such bio/demographic information and any upfront fees and generates an account for the candidate 118. The process 200 may also present legal contracts and/or agreements, such as “terms of use” agreements, to which the candidate 118 may be required to consent in order to register with the service. The process 200 also validates (208) whether the candidate 118 is unique to the platform, e.g., whether the candidate 118 has already registered.

The process 200 verifies the identity of the candidate 118 using authentication information entered by the candidate 118 through the Web portal 152. The authentication information includes a username and password. The authentication information may also include digital certificates that allow the verification logic 154 of the platform 112 to authenticate the identity of the user via third party verification from an independent certificate authority.

Once verified, the process 200 prompts (210) the candidate 118 to enter information to indicate his/her affiliation with an entity, if any (e.g., an institution, organization, company, or university). For example, if the candidate 118 is a student, he/she enters the name of his/her university or college into the user console 116b. After receiving the candidate affiliation information, the process 200 validates (212) whether the candidate is affiliated with the entity as indicated. For example, the process 200 may validate that the candidate's e-mail address domain is affiliated with the entity. If the validation (212) is unsuccessful, the process 200 notifies the candidate and requests the candidate to re-enter his/her entity affiliation.

The process 200 solicits information from the candidate 118 using a series of prompts. For example, the process 200 may send a request to the candidate 118 to enter his/her graduation date or select (214) a date (or expected date) of graduation, select (216) academic specialization(s) (e.g., a major), select (218) field(s) of interest and/or job types of interest (e.g., career fields, such as software development, sales, technical writing, etc.), select (220) geographies of interest; and submit (222) test scores, grades, and experience (e.g., work experience). The information acquired by the process 200 in steps 214, 216, 218, 220, and 222 are collectively referred to as objective information. As described above, in the context of this application, objective information includes factual information that can be independently verified and information relating to an opinion of the candidate that can be wholly verified by the candidate 118.

Based on the information provided by the candidate in one or more of the previous steps, the process 200 presents (224) follow-up questions to the candidate 118 concerning his/her bio/demographic information and/or career aspirations. For example, based on a candidate response indicating an interest in a software engineering job, the process 200 presents follow-up questions to solicit information regarding the kinds of applications that the candidate 118 is interested in and past software development projects the candidate 118 has completed.

The candidate 118 may submit a resume and cover letter (226) and other supporting documents (e.g., portfolio materials, photographs) (228) by uploading or pasting the documents into the Web portal 152. After receiving the resume and cover letter, and other files, if applicable, the process 200 stores them in memory 142 and links them to the candidate profile 155.

The process 200 may prompt the candidate 118 for further information in the form of answers to questions targeting specific behavioral and competency areas. Based on this information, the process 200 quantitatively assesses (230) the candidate's behavioral and personality traits and level of competency in various areas. The process 200 may also assess (232) the candidate's integrity.

The processes 200 uses different query techniques to solicit information from the candidate 118 for the purpose of determining the quantitative assessments. Through the Web portal 152, the platform 112 presents a query, which may be represented as query signal, to the candidates 118 via the console 116b. The query includes questions, e.g., subjective questions to elicit information from the candidate 118. The candidate 118 enters a response to the query into the client 114b via the console 116. The candidate's response is represented as a response signal and is sent from the client 114b to the platform 112.

To elicit information from the candidate 118, the process 200 may prompt the candidate to indicate his/her preference for a given task, his/her own skill level in a variety of competencies, and characteristics that describe him/her.

In addition to behavioral and integrity assessments, the process 200 may assess (234) various skills of the candidate 118 that are specific to the career role for which the candidate 118 has expressed an interest. In assessing a particular skill, the process 200 may ask the candidate 118 to answer a series of questions or take a timed test. For example, the process 200 could request the candidate 118 to take a typing test to assess the number of words per minute or accuracy, at which the candidate 118 types.

The process 200 uses the information collected from the candidate 118 as input to computer algorithms that determine quantitative assessments for the various behavioral and personality traits, integrity qualities, and competency areas being assessed. In some embodiments, the quantitative assessments are raw scores, for example, scores on a proficiency scale. The quantitative assessments may also be in the form of a relative score, e.g., a percentile that represents the candidate's strengths in various areas relative to others with the similar backgrounds or career interests. The quantitative assessments may be represented as signals. For example, the behavioral and personality traits assessments may be represented as trait signals. The assessment signals may be generated by comparing the response signal representative of the candidate's response to a query with a template signal that is representative of a template that defines a desired candidate profile for the particular career role.

Candidates 118 confirm their continued availability or interest in their selected career interests at regular intervals, e.g., every month or every six months. In some embodiments, the platform 112 sends a request for confirmation to the candidate in the form of an e-mail. The candidate, for example, may confirm his/her continued interest by logging into his/her account or sending a reply e-mail to the system. The process 200 initially confirms (236) that the candidate 118 is still available for an employment position, e.g., the candidate 118 has not accepted an employment offer. When confirming ongoing interest, the process 200 may confirm or update (238) and (240) the candidate's bio/demographic information and career interests. During this part of the confirmation process, the candidate 118 may change any portion of the objective information submitted to the platform 112 in steps 214, 216, 218, 220, 222, 224, 226, and 228. Furthermore, the confirmation and updating steps (238) and (240) may be performed at any time upon request of the candidate 118.

The process 200 provides the candidate 118 with the option to update his/her (242) quantitative assessments, which may have included steps 230, 232, and 234. If the candidate 118 elects to update this information, the process 200 repeats one or more of the behavioral assessment 230, the integrity assessment 232, and the job-specific assessments 234. In some embodiments, the candidate 118 is required to repeat all three types of quantitative assessments 230, 232, 234. The process 200 limits the frequency with which the candidate 118 can update his/her quantitative assessments, e.g., once every year, to reduce the likelihood of the candidate 118 being able to reverse engineer the algorithms used for the assessments.

From the quantitative assessments 230, 232, 234, the process 200 may generate (244) a coaching report and may send the report to a career counselor 122 or career center of an entity, e.g., institution, affiliated with the candidate 118. The coaching report may include a summary of the candidate's strengths and weaknesses as determined from the quantitative assessments 230, 232, 234 and provide suggestions to help the candidate 118 improve his/her weaknesses and work towards his/her strengths. For example, if the candidate 118 receives a low score for the personality trait of “assertiveness,” the process 200 may include in the coaching report suggested strategies that the candidate 118 employ so as to appear more assertive.

The process 200 may provide (246) a financial incentive to the candidate 118 after the candidate enters all of the information solicited by the process 200 for creating a candidate profile including determining quantitative assessments for the candidate 118. The financial incentive may, for example, be in a monetary form, in the form of a gift certificate, or other drawing.

After completing the quantitative assessments 230, 232, and 234, the process 200 may provide (248) the candidate 118 with a feedback report, which may include an interview preparation guide and interest area report. The feedback report, for example, may display some of the candidate's strengths and weaknesses as determined from the quantitative assessments. The feedback report provided to a candidate may include the same or similar information contained in the coaching report provided to a career counselor. The feedback report may also include different information from that provided in the coaching report.

The interview preparation guide provides the candidates with suggestions or tips for behaving at the interview and/or for answering certain interview questions. The interest area report provides the candidate 118 with an overall assessment of the candidate's likelihood to succeed in a variety of career areas. The overall assessment may be qualitative, quantitative, or combination of both. When referred by a social networking site, the service may provide the candidate 118 with the option to post information from the feedback report as a public profile report. The public profile report is available to the public and generally will contain only a limited amount of information from the feedback report.

The candidate 118 may request to compare results against another candidate. After the process 200 receives (250) a request for a cross-candidate comparison and permission from the other candidate, the process 200 generates (252) a side-by-side comparison report and provides the report to both parties. The side-by-side report includes a comparison of the candidates' personality and behavioral traits and competency areas. In some embodiments, the side-by-side report provides a one-to-one comparison. The process 200 may also generate (252) a side-by-side comparison report for the candidate 118 and a celebrity-driven profile (e.g., assessments determined for a person having a high profile in a given career). A celebrity-driven profile may be created based on information provided directly from the person being profiled or based on third-party opinions of how the person would answer questions posed by the service in steps 230, 232, and 234. The comparison report may also compare the candidate's profile to a static template in roles such as management, sales, service, or any other individuals that might not be candidates.

When an employer 117 chooses to hire or interview the candidate 118, the process sends (253) a request to the candidate 118. If an offer or interview is accepted, the candidate 118 confirms (254) with the service that an interview or employment offer has indeed been extended. Upon hire confirmation, the process 200 may provide (256) a financial incentive to the candidate, e.g., a sign-on bonus. Upon hire confirmation, the process 200 may inactivate (258) the candidate's profile and temporarily removes it from any lists provided to other employers. Removing the candidate from view of other employers reduces the risk that the candidate 118 will renege on the employment offer that he/she already accepted. In some embodiments, the process 200 removes the candidate from view in the system (1) after the candidate 118 has agreed to accept an interview for a position or (2) after an employment offer has been extended. In the first scenario, the process 200 restores the candidate's profile for display to other employers if the employer decides not to extend an offer to the candidate. In the second scenario, the process 200 restores the candidate's profile for display if the candidate 118 decides not to accept the employment offer. In both of these scenarios, the employer 117 is given a significant advantage over other potential employers who might be interested in hiring the candidate 118.

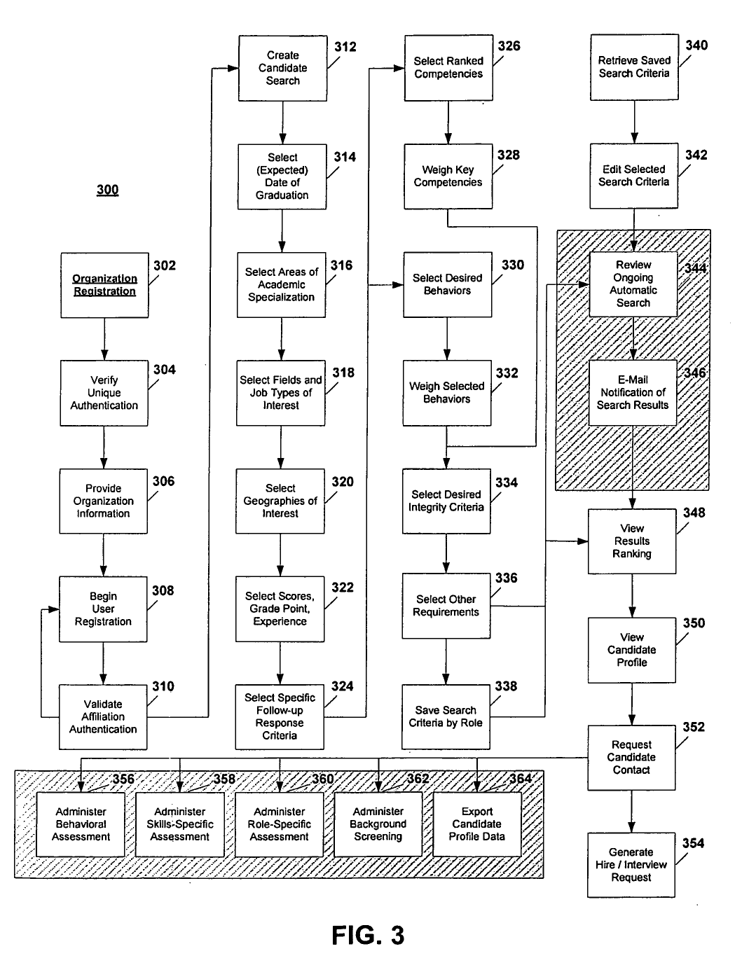

Referring to FIG. 3, the platform 112, operating in conjunction with client computers 116a or 116b, performs a process 300 for providing recruiting services to an employer 117 or to a recruiter 120. For ease of explanation, the process 300 is described only with respect to the employer 117, though the same steps could be performed with the recruiter 120.

The process 300 begins by registering (302) the employer 117 to use the recruiting service. During registration (302), the process 300 solicits information from the employer 117, such as a company name. The process 300 collects any upfront fees from the employer 117, e.g. a registration fee, and generates an account for the employer 117. The process 300 may also present legal contracts and/or agreements, such as “terms of use” agreements, to which the employer 117 may be required to consent in order to register with the service.

The process 300 also validates (304) whether the employer 117 is unique to the platform, e.g., whether a person affiliated with the employer 117 has already registered. The process 300 then solicits (306) organization information to use in generating an employer profile for the employer 117. This information, for example, includes a prospectus, which includes the company contact information and a description of the employer 117, and optionally the composition and structure of the employer 117.

The process 300 registers (308) individual users affiliated with the employer 117 after verifying (310) that the users are indeed affiliated with the employer 117. The process 300 provides each affiliated user with authentication information, e.g., a login and password, for accessing the account belonging to the employer 117.

Through the user console 116a, the process 300 provides (312) the employer 117 with search functions that enable the employer 117 to search for candidates. The tools include dialog boxes, drop-down menus, and buttons that enable the employer 117 to enter a query for candidate profiles that comply with a set of search criteria selected by the user. Examples of search criteria that an employer 117 may enter to source candidates include any portion of the objective information contained in the candidate profiles, which may include career interest, relevant experience, skills, certifications, education, dates or expected dates of graduation, and geographical preference. The process 300 solicits information for the query by presenting the employer 117 with prompts for specific information and/or drop down menus with possible choices, one or more of which the employer 117 can select. As shown in FIG. 3, the process 300 may prompt the employer 117 to select a preferred date (or expected date) of graduation of candidates (314), area(s) academic specialization (316), field(s) of interest and job type interests (318), geographies of interest (320), and test scores, grades (e.g., grade point average), and experience (e.g., work experience) (322). The process 300 may prompt the employer 117 for further information using specific follow-up questions based on the provided data (324).

The process 300 may prompt (326) the employer 117 to select from a list of competency areas, those areas that the employer 117 seeks most in a qualified candidate. In some embodiments, the process 300 limits the employer's selection to a predetermined number of areas, e.g., four areas. After receiving a selection of the areas, the process 300 may prompt (328) the employer 117 to assign weightings or rankings to each of the selected areas. The weighting assigned to a particular area indicates the relative importance of that area with respect to the other selected areas. In some embodiments, weightings are values ranked in order from highest to lowest and/or selected from a range or scale (e.g., a scale of 1 to 10) where the lowest value of the range represents the highest degree of importance and the highest value represents the lowest degree of importance as perceived by the employer 117. In some embodiments, the weightings are values that collectively sum to a predefined value, e.g., 100 or 100%. For example, given the requirement that the sum of the weightings is equal to 1.0, the weightings assigned to four competency areas could be 0.5, 0.2, 0.2, and 0.1. The area assigned the weighting of 0.5 is considered to have the highest relative degree of importance compared to the other three areas; the area assigned the weighting of 0.1 has the lowest relative degree of importance, and the two areas assigned the weightings of 0.2 are of equal importance relative to each other.

The process 300 may prompt (330) the employer 117 to select from a list of behavioral and personality traits, those traits that the employer 117 seeks most in a qualified candidate. As with step 326, the process 300 can limit the employer's selection to a predetermined number of traits, e.g., ten areas. After receiving a selection of the traits, the process 300 may prompt (332) the employer 117 to assign weightings to each of the selected traits to indicate the relative importance of the traits. In some embodiments, weightings are values ranked in order from highest to lowest and/or selected from a range or scale (e.g., a scale of 1 to 10) where the lowest value of the range represents the highest degree of importance and the highest value represents the lowest degree of importance as perceived by the employer 117. In some embodiments, the weightings are values that collectively sum to a predefined value, e.g., 100 or 100%. In some embodiments, one or more aspects of the traits criteria is absolute, meaning that the assessment of a candidate's particular trait must meet a threshold value in order to be considered for a position with the employer 117. In some embodiments, the employer 117 can specify that a candidate must meet a minimum percentage of the trait criteria specified by the employer 117. For example, the candidate must pass 4 out of 5 types of employer-selected trait criteria.

The process 300 may prompt (330) the employer 117 to select integrity criteria that a qualified candidate is expected to meet. In some embodiments, one or more aspects of the integrity criteria is absolute, meaning that the quantitative integrity assessment of a candidate must meet the integrity criteria in all respects to be considered for a position with the employer 117. In some embodiments, the employer 117 can specify that a candidate must meet a minimum percentage of the integrity criteria specified by the employer 117. For example, the candidate must pass 4 out of 5 types of employer-selected integrity criteria.

The process 300 prompts (336) the employer 117 to select any other job-specific requirements desired for a qualified candidate. Examples of requirements include a minimum typing speed, specific certifications, particular skills, intelligence test scores, proficiencies in one or more specific languages, and prior work experience in one or more particular fields.

The process 338 saves (338) the search criteria entered by the employer 117 under a name provided by the employer 117, e.g., the name of a career role to which the search criteria corresponds. When saved, the search criteria are accessible to the employer 117 through the employer's profile. For example, an employer may access search criteria by typing in an identifier corresponding to the criteria or by selecting an identifier from a list of identifiers corresponding to various search criteria.

When the process 300 receives a selection of a search-criteria identifier from the employer 117, it retrieves (340) the saved search criteria corresponding to the selected identifier. The process 300 provides (342) the employer 117 with the option to edit one or more portions of the search criteria. For example, the employer 117 may change one or more of the weightings that were previously assigned to the competency areas or behavioral traits. The criteria entered by an employer 117 for evaluating candidates for a specific role is collectively referred to as a “template.” A template represents the qualities, skills, and experience that an ideal or high-qualified candidate for a given position as determined by the employer 117.

The process 300 generates a query from the information selected by the employer 117 in steps 314, 316, 318, 320, 322, 324, which may include, but is not limited to, date or expected graduation date, academic specialization, fields of interest, geography of interest, job type and rate of pay and searches (344) the database 126 for candidate profiles that match the criteria included in the query. In some embodiments, the query may include different and/or additional criteria than that described above. The query may also include selected behavioral and personality and/or integrity criteria (received at step 334) and other requirements (received at step 336). The search may return one or more candidate profiles that comply with the search criteria included in the query. These candidate profiles are referred to as “search results.” The process 300 may notify (346) the employer 117, e.g., via e-mail that search results have been obtained. The search may be set as “ongoing” with notifications of matches sent to the employer 117 by e-mail.

The process 300 may determine a score for a candidate returned from the search results based on the objective information and/or the candidate's quantitative assessments corresponding to the selected competency areas and behavioral and personality traits and/or integrity criteria selected by the employer 117 and may also be based on the weightings assigned by the employer 117 to those competency areas and behavioral and personality traits and/or integrity criteria. The score may be represented as a score signal and the weightings may be represented as weighting signals. The processor 140 of the platform 112 processes the signals representative of quantitative assessments and the weighting signals to generate the score signal.

In some embodiments, the process calculates a score as weighted averages, i.e., an average of the selected quantitative assessments each scaled by the respective weightings assigned by the employer 117. The scores assigned to a candidate returned by the search correspond to the likelihood of the candidate 118 to match the career role or employment position offered and defined by the employer 117.

The process 300 presents the search results to the employer 117 through the console 116a. In addition or alternatively, the process 300 may present the search results in an electronic file delivered to the employer 117 via e-mail or present the results in hard-copy form, e.g., via mail or facsimile.

When presenting the search results to the employer, the process 300 ranks (348) the results according to their scores and/or other criteria, with the highest scoring candidates listed at the top of a list of returned candidates. The process 300 may also designate the highest corresponding candidates using other forms of visual display. The process 300 provides (350) the employer 117 with access to individual profiles of those candidates presented in the search results. For example, activation of a control, e.g., a button, located in proximity to the name of a candidate may cause that candidate's profile to be displayed in the user console 116a. In some embodiments, clicking on the candidate's name itself may cause the candidate's profile to be displayed in the console 116a. In some embodiments, only a limited portion of the candidate's profile is displayed to the employer 117. For example, the candidate's contact information may be omitted from display. After considering information shown in the search results, the employer 117 may decide to take the next step to contact a candidate featured in the results.

The process 300 provides (352) mechanisms by which the employer 117 can contact a candidate for further information, e.g., to schedule an interview with the candidate. In some embodiments, the process 300 provides the employer 117 with all or a portion of the candidate's contact information (e.g., telephone number, e-mail address, and home address), which is included in the candidate's profile.

After receiving the employer's selection of a candidate from the search results, the process 300 optionally provides the employer 117 with access to a number of additional features, which include additional behavioral assessments (356), skill-specific assessments (358), and role-specific assessments (360), background screening (362), and the capability to export (364) one or more portions of the search results to other corporate systems or databases. The process 300 may provide a guide to the employer 117 that contains feedback and/or verbal coaching advice for further screening the candidate 117. For example, the guide may include suggested interview questions tied to an individual candidate's strength and weakness as determined from the quantitative assessments.

The process 300 sends a new hire request (354) to the candidate 118 to confirm whether he/she has accepted an employment offer from the employer 117. If the candidate 118 has accepted an employment offer, the process 300 temporarily removes that candidate's profile from view of other employers, otherwise the candidate's profile remains viewable to other employers.

In some embodiments, the new hire request may be tied to a specific date on which it is subject to expiration; and multiple requests may be made by multiple employers concurrently, i.e., one per employer. In addition, in some embodiments, employers may submit a “bid” to the platform 112 for the opportunity to contact and/or hire the candidate. The platform 112 may: 1) display the employer and bid to other employers, 2) withhold the employer's identity, but display the bid to other employers, or 3) withhold from other employers all information concerning the bid, among other options.

The candidate recruiting service may employ a variety of revenue models and fee schedules. In some revenue models, candidates 118 may register with the service for free. Employers 117 and recruiters 120 pay a registration fee to access the service and a contingency fee (e.g., a flat-rate fee or a variable fee) for each candidate 118 that is successfully appointed to a position through the service. Contingency fees may be assessed only when a candidate 118 accepts an employment offer as a direct result of being introduced through the employer 117 or recruiter 120 through the recruiting service. In some embodiments, the service implements a tiered pricing structure in which employers 117 and recruiters 120 have the option to pay “per hire,” to purchase a “package” that grants a predefined number of hires (e.g., 10 hires) within a predetermined time period (e.g., a month or a year), or to pay for unlimited hires within a predetermined time period (e.g., a subscription). In some embodiments, contingency fees may be assessed to employers 117 and not recruiters 120, who, for example, may be assessed higher registration fees. Contingency fees, as well as registration fees, may vary depending on the size of the employer 117 (e.g., the number of employees), whether the employer 117 is for-profit or non-profit, and/or based on other factors.

Other fees may also be charged to the employer 117 and the recruiter 120. For example, an additional fee may be charged to an employer 117 after the employer 117 and a candidate 118 have made initial contact (e.g., via e-mail or other messaging system) via the recruiting service. Advanced services and reports, including additional behavioral assessments (356), skill-specific assessments (358), role-specific assessments (360), background screening services (362), and export services (364) may be offered to the employer 117 for an additional fee on an a subscription and/or a la carte basis.

The service may exact fees from the candidate 118 and the career counselor 122 for providing reports based on the quantitative assessments of the candidate 118. In some embodiments, the reports show the relative scores of the candidate 118 compared to others for a particular career role. In exchange for a fee, the service may provide the candidate 118 with interview advice and practice interview questions corresponding to the candidate's strengths and weaknesses. Candidates 118 may also purchase side-by-side reports showing a comparison of quantitative assessments with another candidate or with a celebrity or well-known person of the candidate's choice.

The reports provided to the career counselor 122 may include a comprehensive evaluation of one or more candidates affiliated with the institution to which the career counselor 122 is also affiliated. In some embodiments, the service implements a tiered pricing structure in which the career counselor 122 has the option to pay “per candidate report,” to purchase a “package” that grants a predefined number of reports (e.g., 20 reports) within a predetermined time period (e.g., a month or a year), or to pay for unlimited reports within a predetermined time period (e.g., a subscription).

In some embodiments, the platform 112 aggregates information from the candidate profiles, and from the information, aggregates statistics and derives further data which may be sold to employers 117, recruiters 120, career counselors 122, and third parties that are not registered with the recruiting service. Additionally, the data may be used to generate highly targeted direct marketing lists that are available for purchase. For example, the platform 112 identifies graduating students, anticipated geography and expected income, and may sell lists of matching individuals, whose qualifications, background, interests and other associated information match particular criteria for direct mail pieces. Furthermore, the platform 112 can tailor the marketing lists according to one or more quantitative assessments determined for the candidates, including behavioral and personality assessments, competency area assessments, and job-specific skills assessments, to implement strategies most likely to succeed with those parties to whom the marketing pieces are sent, thus improving the quality of direct marketing.

Using the aggregated data, the platform can identify a suitable subset of the candidates to partake in a marketing survey based on information supplied by the party conducting the survey.

The candidate recruiting service may require users to sign legal contracts to sway them against making or accepting “backdoor” offers that are made outside of the parameters of the service in an effort to avoid the contingency fee after the details of a candidate 118 are culled through the service. When it has been determined that a company has made or attempted to make a backdoor offer, the service may dismiss the company immediately from the service, apply the contingency fee anyway and retain whatever other rights it may have at law or equity. Similarly, a candidate 118 that accepts or attempts to accept backdoor offers may have their account deleted and be banned from using the service indefinitely.

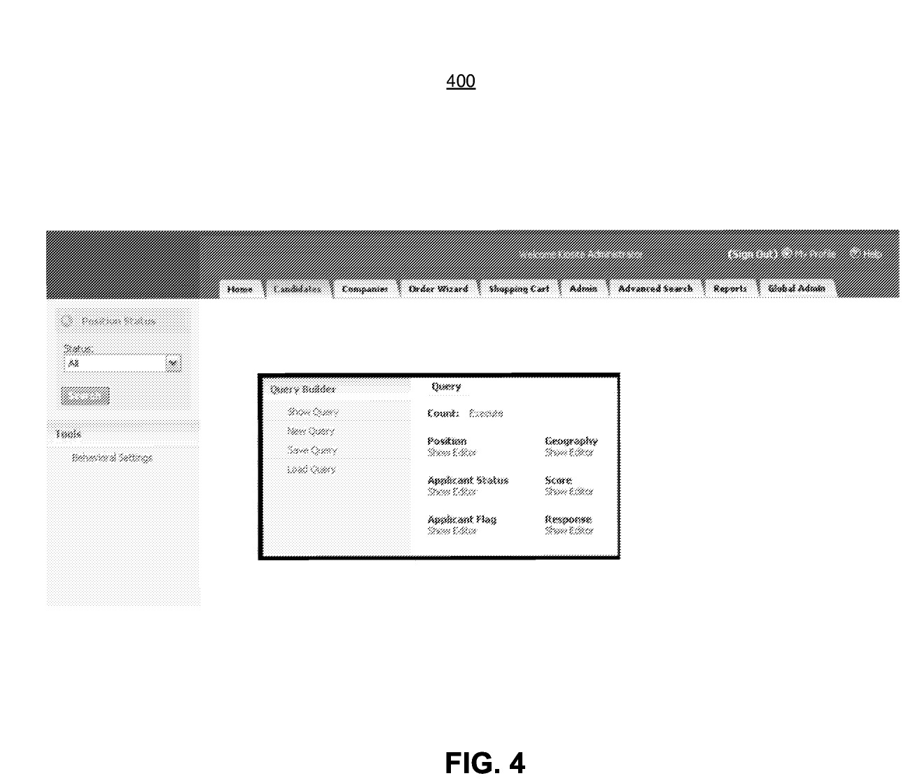

FIGS. 4-7 show exemplary features provided by the user consoles 116a and 116c for enabling employers 117 and recruiters 120 to screen candidates 118 through the candidate recruiting platform 112. For ease of explanation, the tools will be described with respect to the employer 117, however, the recruiter 120 can also use the tools in a similar manner.

FIG. 4 shows an example of a searching console 400 that enables the employer 117 to identify those candidates that meet employer-specific criteria. Within the searching console 400, the employer 117 builds a query to select various requirements that a qualified candidate should meet. These may include, for example, an expressed interest in a particular career field, a particular geographic preference, a date (or expected date) of graduation, a minimum grade point average, integrity criteria, and job-specific skill. Other criteria could be included in the query as well. Not shown in FIG. 4, the employer 117 also selects weightings for a number of the key competency areas assessed for the candidates 118. The weightings indicate a degree of importance with which the employer regards a high aptitude in each of the selected competency areas. The employer also assigns weightings to different types of quantitative assessments for personality and behavior that were determined for the candidates. These assessments may include evaluations based on one or more of: the candidate's ranking of interest in specific competency areas; the candidate's self-assessment of skill; the candidate's experience; measurement of behavior and integrity, and the candidate's answers to questions presented by the platform 112.

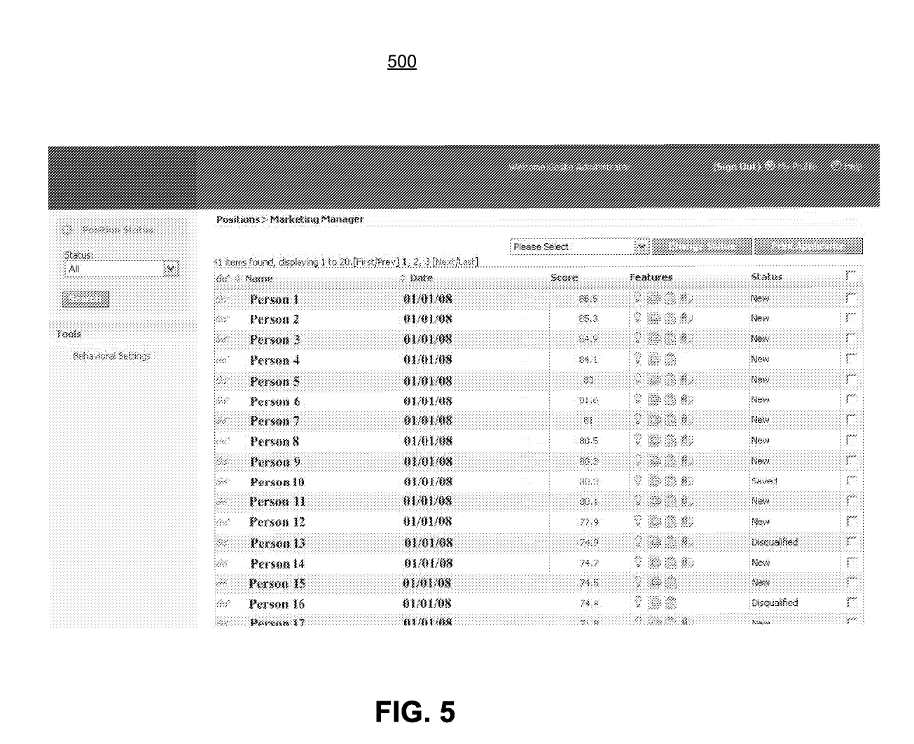

FIG. 5 shows an example of a results report 500 that shows candidates that have been returned in response to the query. The candidates are automatically rank-ordered based upon their match to the career role, which is represented by a score that has been calculated, for example, based on the quantitative assessments and based on the weightings for the competency areas and types of assessments assigned by the employer 118 in the search console 400. The results report 500 provides the employer 117 with links to additional features, such as detailed behavioral assessments, skills-specific assessments, and role-specific assessments. In some embodiments, the service only displays those candidates whose scores exceed a given threshold value.

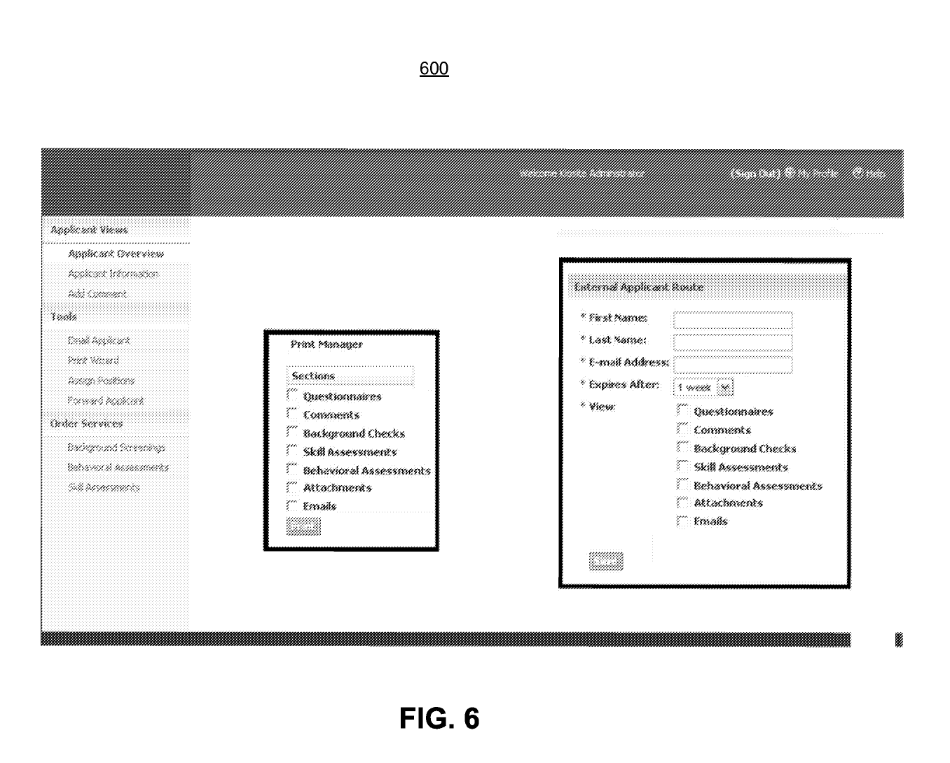

FIG. 6 shows an example of an export page 600 that provides an employer 117 with the capability to export various results of the screening process to other individuals, divisions, or entities. The employer 117 may provide information to an external entity through electronic means, e.g., via e-mail, or in the form of hardcopy reports, in which case the employer 117 may print those sections that are to be exported. The export screen presents a list of available assessments and services and a prompt in which the employer 117 enters the name and e-mail-address of the receiving entity. The employer 117 can select which reports the receiving entity is allowed to view and a time after which the reports are no longer available, i.e., an expiration time.

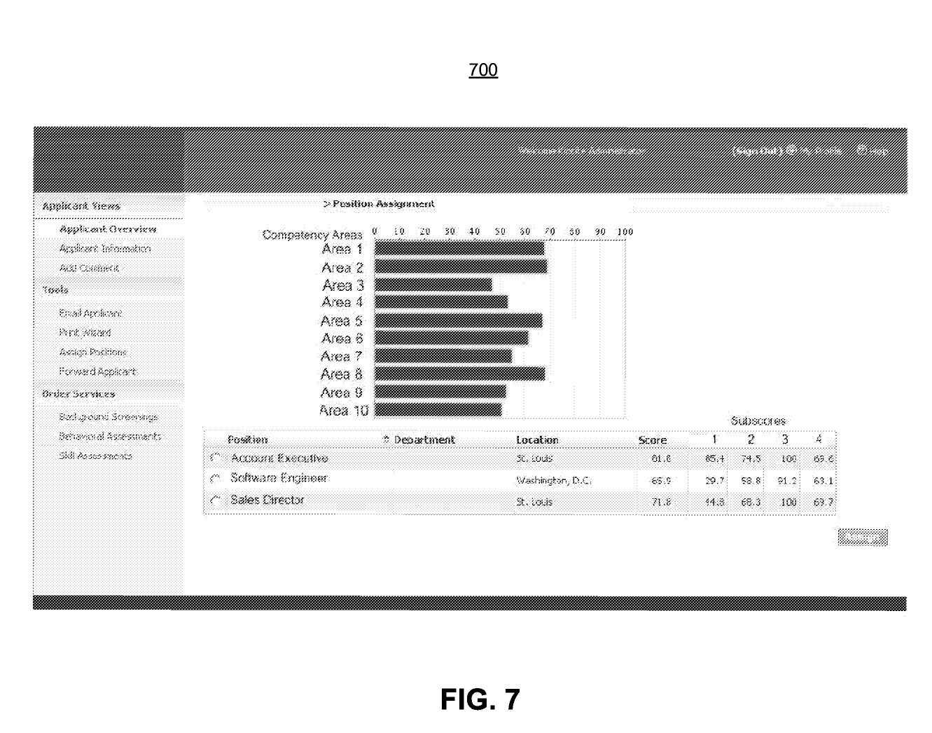

FIG. 7 shows an example of a comparison report 700 that shows how the candidate 118 would have scored for different career roles. The chart compares the candidate against other career roles or other career templates. For example, the comparison report may compare the quantitative assessments included in a candidate's profile to a static template for a particular career role that was predefined by the employer 117. The employer 117 can select the career roles for which the candidate 118 is evaluated, and from the results of the report 700, determine those career roles that would best suit the candidate 118. For example, the report 700 may present the career roles ranked according to the corresponding scores, e.g., from highest to lowest.

A number of embodiments of the invention have been described. Nevertheless, it will be understood that various modifications may be made without departing from the spirit and scope of the invention. The foregoing are examples for illustration only and not to limit the alternatives in any way.

The computer processes described herein, including process 200, can be implemented in digital electronic circuitry, or in computer software, firmware, or hardware, including the structural means disclosed in this specification and structural equivalents thereof, or in combinations of them. The processes can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes described herein, including method steps, can be performed by one or more programmable processors executing one or more computer programs to perform functions of the processes by operating on input data and generating output. The processes can also be performed by, and apparatus of the processes can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer-readable media suitable for embodying computer program instructions and data include all forms of nonvolatile memory, including by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The processes can be implemented in a computing system that includes a back end component (e.g., a data server), a middleware component (e.g., an application server), or a front end component (e.g., a client computer having a graphical user interface or a Web browser through which a user can interact with an implementation of the processes), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The steps of the processes 200 and 300 may be performed in orderings other than those shown in corresponding FIGS. 2 and 3. For examples, some of the steps in either of the processes 200 and 300 may be eliminated, repeated, or combined with additional steps. Elements of different embodiments described herein may be combined to form other embodiments not specifically set forth above. Accordingly, other embodiments are within the scope of the following claims.

What is claimed is:

1. A computer-implemented method for recruiting candidates comprising:
processing trait signals representative of quantitative assessments of traits possessed by a candidate and weighting signals representative of relative degrees of importance of the traits perceived by the employer to provide a score signal based on the trait signals and weighting signals; and
transducing the score signal to an observable form.

2. The method of claim 1, wherein the score signal represents a likelihood that the candidate will succeed in a particular career role.

3. The method of claim 1, wherein the assessments of traits include assigning individual values to the trait signals, the method further comprising:
providing the score signal as a weighted average of the individual values each scaled by a corresponding one of the weighting signals.

4. The method of claim 1, further comprising:
providing a report showing the transduced score signal of the candidate relative to transduced score signals of other candidates determined for a particular career role.

5. The method of claim 1, further generating signals representative of measures of one or more of conscientiousness, integrity, objective information, and job-specific skills possessed by the candidate; and wherein processing to provide a score further comprises:
additionally processing the generated signals.

6. A computer-implemented method for recruiting candidates comprising:
receiving an interest signal representative of an indication of interest in a particular career role from a candidate;
generating a query signal representative of a query targeted to the particular career role for soliciting information from the candidate;
transducing the query signal to an observable form displayed to the candidate;
receiving a response signal representative of the response of the candidate to the transduced query signal; and
determining a measure of competency of the candidate for the particular career role by comparing the response signal with a template signal received from an employer, the template signal being representative of a template that defines a desired candidate profile for the particular career role.

7. The method of claim 6, wherein transducing the query signal displays one or more questions to elicit information that describes a level of skill of the candidate in one or more competency areas.

8. The method of claim 6, wherein transducing the query signal displays one or more subjective questions to elicit information that characterizes a personality of the candidate.

9. The method of claim 6, wherein the template signal includes weighting signals representative of weightings assigned to traits and competency areas by the employer, the weighting signals representative of a degree of importance of the corresponding traits and competency areas as perceived by the employer.

10. The method of claim 6, further comprising regenerating the query signal and transducing the regenerated query signal into observable form displayed to the candidate only after a predetermined amount of time has passed since the query signal was previously transduced into an observable form displayed to the candidate.

11. A computer-implemented method for recruiting candidates, the method comprising:
storing user profiles in memory, user profile data received from candidates interested in a career opportunity, the user profile data including objective information provided by the candidates and quantitative assessments of behavioral and personality traits of the candidates;
filtering the user profiles based on criteria signals representative of criteria selected from the objective information; and
ordering remaining user profiles according to scores assigned to the user profiles and determined from the quantitative assessments.

12. The method of claim 11, wherein the objective information includes one or more of: contact information of the candidates, career interests, geographic preferences, dates or expected dates of graduations, previous work experience, names of degree-granting institutions, major or field of study, grade point averages, and standardized test scores.

13. The method of claim 12, further comprising:
determining the scores based in part on a degree of matching between the criteria and the objective information included in the user profiles.

14. The method of claim 11, wherein the quantitative assessments of behavioral and personality traits include values corresponding to traits, and further comprising:
determining the scores using a weighted average mathematical function applied to the values and weightings assigned to the traits.

15. The method of claim 11, further comprising:
validating one or more portions of the objective information for one or more of the candidates.

16. A computer-implemented method comprising:
determining score signals representative of scores corresponding to candidates, the scores representing a likelihood of the candidates succeeding in career roles for which the candidates have expressed interest, the scores determined, at least in part, from quantitative assessments of behavioral and personality traits of the candidates;
producing an information signal representative of information derived from one or more of the quantitative assessments and scores; and
deriving revenue from a third in exchange for transducing the information signal into an observable form for display to the third party.

17. The method of claim 16, wherein the third party comprises an employer and wherein transducing the information signal into an observable form comprises displaying one or more of: the scores corresponding to the candidates, interests and experience of the candidates, strengths of the candidates, and skills of the candidates.

18. The method of claim 17, wherein transducing the information signal into an observable form further comprises displaying behavioral-based interview questions corresponding to candidate strengths and weaknesses determined from the quantitative assessments.

19. The method of claim 16, wherein the third party comprises an institution, and wherein transducing the information signal into an observable form comprises displaying a report including a comprehensive evaluation of one or more candidates affiliated with the institution, the comprehensive evaluation based on the quantitative assessments.

20. The method of claim 16, wherein the third party comprises one of the candidates, and wherein transducing the information signal into an observable form comprises displaying a report showing strengths and weaknesses of the candidate derived from a corresponding one of the quantitative assessments of behavioral and personality traits.

21. The method of claim 16, wherein the third party comprises one of the candidates, and wherein transducing the information signal into an observable form comprises displaying a report showing a comparison of quantitative assessments associated with the candidate and another individual.

22. The method of claim 21, wherein the individual is one of the candidates.

23. The method of claim 20, wherein the third party comprises one of the candidates, and wherein transducing the information signal into an observable form comprises displaying a report showing a comparison of quantitative assessments associated with the candidate and a predefined template representative of a highly qualified candidate for a particular career role.

24. A computer-implemented method comprising:
enabling a user affiliated with an employer to access a list of candidates from an online system, the list of candidates ranked according to a measure of qualification for a career role, the measure of qualification determined based on a quantitative input signal representing quantitative input provided by the employer, the quantitative input being representative of a desired candidate for the career role; and
compensating a provider of the online system before or after completion of an activity involving one or more candidates from the list.

25. The method of claim 24, wherein compensating comprises one or more of: a subscription, a fixed fee, and a variable fee.

26. The method of claim 24, wherein the activity comprises transducing an invitation signal representative of an interview offer or an employment offer to an observable form for display to one of the candidates.

27. The method of claim 25, wherein the fixed fee or the variable fee is collected from the employer after the employer hires a candidate from the list.

28. The method of claim 25, wherein the fixed fee or the variable fee is collected from the employer after one or more predetermined intervals of time.

29. The method of claim 24, further comprising:
in response to receiving a confirmation signal representative of an acceptance of an employment offer by a candidate from the list, preventing display of profile data of the candidate to other employers.

30. The method of claim 24, further comprising:
providing a financial incentive to a candidate included in the list in exchange for the candidate providing information to the online system.

31. The method of claim 24, further comprising:
providing a financial incentive to a candidate included in the list after the candidate has accepted an employment offer from the employer.

32. A system for recruiting candidates comprising:
memory storing information received from candidates and quantitative assessments of behavioral and personality traits of the candidates, and weightings provided by a user affiliated with an employer, the weightings indicating relative degrees of importance of the behavioral and personality traits; and
one or more processors configured to determine scores for the candidates based on the quantitative assessments and based on the weightings.

33. The system of claim 32, wherein the one or more processors are further configured to deliver a report to a user, the report including a ranking of candidates according to the scores.

34. The system of claim 32, wherein the memory stores templates defined by employers, the templates being representative of ideal candidates for the particular career roles and including the weightings.

35. The system of claim 32, further comprising:
a validation module configured to verify information provided by the candidates and employers.

36. A computer-implemented method for candidate recruiting comprising:
storing in memory, user profile data received from candidates interested in a career opportunity, the user profile data including objective information provided by the candidates and quantitative assessments of behavioral and personality traits of the candidates;
generating statistical information from the user profile data; and
generating a direct marketing list based on the statistical information, the direct marketing list being available for purchase by one or more third parties.

37. The method of claim 36, further comprising:
tailoring the marketing list according to the quantitative assessments determined for the candidates, wherein the quantitative assessments include one or more of: behavioral and personality assessments, competency area assessments, and job-specific skills assessments.

38. A computer-implemented method for recruiting candidates comprising:
receiving trait signals representative of quantitative assessments of traits possessed by a candidate;
receiving multiple sets of weighting signals, wherein each set of weighting signals represents relative degrees of importance of the traits for a particular career role as perceived by an employer, the multiple sets corresponding to different career roles;
processing the trait signals and the weighting signals corresponding to each of the sets to provide score signals representative candidate's suitability for the career roles corresponding to each of the sets; and
transducing the score signals to an observable form.

39. The method of claim 38, wherein the assessments of traits include assigning individual values to the trait signals, and wherein processing the trait signals and the weighting signals further comprises:
providing each of the score signals as a weighted average of the individual values each scaled by a corresponding one of the weighting signals.

40. The method of claim 38, further comprising ranking the career roles according to their corresponding scores.
